(19) United States
(12) Patent Application Publication
(10) Pub. No.: US 2026/0262752 A1
(43) Pub. Date: Sep. 10, 2026

(54) AEROSOL-GENERATING SYSTEM WITH CONNECTOR COVER ELEMENT

(71) Applicant: Philip Morris Products S.A., Neuchatel (CH)

(72) Inventors: Sze Chiek AW, Singapore (SG); Chow Kian YEO, Singapore (SG); Ching Hung HII, Singapore (SG); Swee Min LIEW, Singapore (SG)

(73) Assignee: Philip Morris Products S.A., Neuchatel (CH)

(21) Appl. No.: 18/848,329

(22) PCT Filed: Mar. 24, 2023
(86) PCT No.: PCT/EP2023/057666

§ 371 Date: Sep. 18, 2024

(30) Foreign Application Priority Data
Mar. 24, 2022 (EP) 22164111.1

(51) Int. Cl. A24F 40/95; A24F 40/70; H02J 7/70

(52) U.S. Cl. CPC A24F 40/95; A24F 40/70; H02J 7/70

(57) ABSTRACT

An aerosol-generating system is provided, including: a housing including a connector opening, in which the connector opening is at least partially covered by a cover element, in which the cover element includes at least one flap, in which the at least one flap is movable from a closed position to an open position, in which the at least one flap is configured to open towards an inside of the housing, in which an outer surface of a housing wall includes at least one connector opening edge adjacent to the connector opening, and in which the at least one connector opening edge is configured to be in surface contact with the respective at least one flap. An assembly method for the aerosol-generating system is also provided.

The present invention relates to an aerosol-generating system with a cover element, an assembly method for an aerosol-generating system, and the use of a flap in an aerosol-generating system.

There is a need for improving the sealing of aerosol-generating systems, in particular against dust and liquids. There is also a need for improving usability of aerosol-generating systems.

According to a first aspect of the invention, an aerosol-generating system is provided with a housing comprising a connector opening. The connector opening is at least partially covered by a cover element. The cover element comprises at least one flap. The at least one flap is movable from a closed position to an open position. In the closed position, the flap may reduce the ingress of liquids, in particular water, or contaminations into the device. The flap may prevent malfunction of the system caused by liquids that enter into the system. In the open position, the flap may uncover the connector opening, such that a plug can be inserted into the connector opening.

The aerosol-generating system, in particular the housing, may comprise a connector. The connector opening may provide an opening for the connector. The connector may be an electrical connector. The connector may comprise an electrical conductor. The aerosol-generating system may comprise an electrical connector and the connector opening of the housing may be an opening for an electrical connector. The connector may be configured to enable electrical charging of the aerosol-generating system or a part of the aerosol-generating system. The connector may be a gas charging port. The connector may be a liquid charging port. The connector opening may be an electrical connector opening, an opening for a gas charging port and/or an opening for a liquid charging port. The present invention may be applied to any type of connector. This also applies to the other aspects of the invention.

The at least one flap may be adapted to open towards the housing. Such a configuration may improve usability of the aerosol-generating system. The user may push a plug against the flap to form an opening in the cover element and insert the plug into the connector opening. This may render unnecessary the additional step of previously opening or removing the cover element before inserting the plug into the connector opening.

According to a second aspect of the invention, an aerosol-generating system is provided with a housing, an electrical connector and a sealing member. The housing comprises a housing wall. The electrical connector comprises a plug reception opening and a connection flange. The plug reception opening may be a cavity adapted for receiving a plug in the electrical connector. The connection flange extends at least partially around the plug reception opening. The sealing member is arranged between the connection flange and an inner surface of the housing wall. The sealing member may reduce the ingress of liquids, in particular water, or contaminations into the device. The sealing member may prevent malfunction of the system and may prevent damage of the electrical connector.

The electrical connector may have a front section and a back section. The plug may be inserted via the front section into the electrical connector. The back section is at the opposite side of the front section. The longitudinal direction of the electrical connector may be defined by an axis extending from the front section towards the back section. A lateral direction may be any direction orthogonal to the longitudinal direction.

The electrical connector may be a USB connector. The electrical connector may be connected, in particular soldered, to a printed circuit board assembly (PCBA). A coating, in particular a plastic coating, may be applied to protect the solder joints. The coating may be a glue, a polymer, or a combination thereof. The coating may protect the printed circuit board assembly from dust and liquid.

The housing may comprise a connector opening. The connector opening may be adjacent to the electrical connector, in particular the front section of the electrical connector. A plug may be inserted into the electrical connector through the connector opening. The connector opening may be at least partially covered by a cover element. The cover element may comprise at least one flap. The at least one flap is adapted to open towards the inside of the housing.

The sealing member may be arranged in a lateral distance, namely a distance in the lateral direction, from the plug reception opening to form a lateral clearance, namely a clearance in the lateral direction, between the sealing member and the plug reception opening. The lateral clearance may prevent that a plug interferes with the sealing member, in particular when the plug is inserted into or removed from the plug reception opening. This configuration may improve durability of the sealing member and usability of the aerosol-generating system. An inner surface of the sealing member may be substantially flush with the connector opening in the housing. An inner edge of the sealing member may be aligned with the connector opening in the housing. The lateral clearance may be the lateral distance between the connector opening and the plug reception opening.

The lateral clearance may extend circumferentially around the plug reception opening. The lateral clearance may have a width of at least 0.1 millimeters, in particular 0.2 millimeters, in particular at least 0.3 millimeters. The maximum width of the lateral clearance may be 30 millimeters. The lateral clearance may be uniform along its extension around the plug reception opening. The lateral clearance may have substantially the same width along its extension around the plug reception opening. The width of the lateral clearance may vary along its extension around the plug reception opening, in particular it may vary depending on the shape of a plug that may be inserted into the plug reception opening.

The connector opening may have a substantially oval shape. The connector opening may have a substantially circular shape. The connector opening and the plug receiving opening may have substantially the same shape.

The aerosol-generating system may comprise a battery charger and an aerosol-generating device. The housing may form part of the battery charger. The aerosol-generating device may be completely insertable into the battery charger. The sealing member may be located inside the battery charger and may reduce the ingress of liquids or contaminations into the inside of the battery charger, such that both the battery charger and the aerosol-generating device are substantially protected from liquids or contaminations. The sealing member may prevent malfunction of the system.

The aerosol-generating system may comprise an aerosol-generating device. The housing may form part of the aerosol-generating device. The sealing member may be located inside the aerosol-generating device and may reduce the ingress of liquids or contaminations into the aerosol-generating device.

The aerosol-generating system may comprise an aerosol-generating article with an aerosol-generating substrate. The aerosol-generating article may be a cartridge. The aerosol-generating article may comprise an aerosol-generating substrate. The aerosol-generating device may comprise a cavity. The cavity may be adapted to receive an aerosol-generating article with an aerosol-generating substrate. The aerosol-generating substrate may be in liquid or solid form. The aerosol-generating substrate may comprise tobacco or herbal material. The aerosol-generating substrate may be tobacco, herbs, a liquid, in particular oil, an artificially produced substrate, or a combination thereof.

The housing may comprise a housing wall. The cover element may be attached to an inner surface of the housing wall. Such a configuration may protect the cover element and improve durability of the cover element. The cover element may extend into the connector opening in the housing wall, such that the outer surface of the housing wall and the cover element are substantially levelled. The outer surface of the housing wall and the outer surface of the cover element may be continuous. Such a configuration may reduce the accumulation of contamination inside the connector opening and may improve usability.

The cover element may also be attached to an outer surface of the housing wall. Such a configuration may enable an easier replacement of the cover element. A recessed section may be formed in the outer surface of the housing wall to provide space for the cover element. The depth of the recessed section may be substantially equal to the thickness of the cover element, such that the outer surface of the housing wall and the cover element are substantially on the same level.

The cover element may comprise a support structure and the support structure may be attached to the housing wall. The cover element may be indirectly attached to the housing wall. A spacing element may be provided between the cover element and the housing wall.

The cover element may overlap with the housing wall, in particular by 0.5 millimeters to 10 millimeters, in particular by 1 millimeter to 5 millimeters. The overlap may be adapted to seal the connector opening. The overlap may form an attachment area of the cover element to the housing wall.

The flap may be bonded to the housing wall, in particular by an adhesive, in particular glue, or double side adhesive tape.

The cover element may substantially seal the connector opening when the at least one flap is in the closed position. The cover element may be substantially waterproof when the at least one flap is in the closed position. The cover element may be substantially impermeable to liquids when the at least one flap is in the closed position. The cover element may be substantially dustproof when the at least one flap is in the closed position.

The cover element may comprise an attachment portion. The attachment portion may be at least partially attached to the housing wall. The at least one flap may be connected to the attachment portion. The at least one flap may be adapted to bend towards the inside of the housing, while the attachment portion may remain stationary.

The attachment portion may extend at least partially around the at least one flap, preferably the attachment portion extends circumferentially around the at least one flap. Such a configuration may provide a good structural support for the at least one flap. The attachment portion and the at least one flap may be formed from the same material. The attachment portion and the at least one flap may be formed from a unitary piece. The attachment portion and the at least one flap may be separate parts that are connected by a connection element or an adhesive.

The at least one flap may be adapted to elastically move from an open position to a closed position. The term elastically may mean that the at least one flap moves from the open position to the closed position due to internal forces within the flap, in particular restoring forces within the flap, in particular resulting from the deformation of the flap. In the closed position, the at least one flap may at least partially cover the connector opening. The at least one flap may move to the closed position without the application of an external force. This may mean that the movement of the at least one flap from the open position to the closed position is caused by a force other than an external force, in particular cause by an internal force. The term external may mean that force does not result from the at least one flap itself. For example, the external force may be provided by another component of the aerosol-generating system or device, or the user. The connection opening may be covered and sealed immediately (or automatically) after a plug has been disconnected from the connector opening. This may be convenient for the user and may additionally prevent the intake of liquids or contaminations into the aerosol-generating system.

A cover element opening may be formed in the cover element when the at least one flap is in the open position. The cover element opening may be formed when an external object, in particular a plug, for example a USB plug, is pushed against the at least one flap. The cover element opening may be formed in the middle of the cover element or from a peripheral edge of the cover element, depending on where the at least one flap is located inside the cover element. The plug may then be inserted through the cover element opening to connect with a connector inside the aerosol-generating system. When the external object is removed from the aerosol-generating system, the at least one flap may return to a closed position and substantially close the cover element opening.

The cover element may comprise at least one bending line between the at least one flap and the attachment portion. The at least one bending line may facilitate bending of the at least one flap. The at least one bending line may be a groove or multiple grooves. The groove may be formed on the outer surface of the cover element or on the inner surface of the cover element. The groove may be formed on both surfaces of the cover element.

The cover element may comprise a first slit. The cover element may comprise at least one second slit. The at least one second slit may be connected to the first slit. The first slit and the at least one second slit may be arranged between the at least one flap and the attachment portion. The first slit and the at least one second slit may also be arranged between two adjacent flaps. At least one of the slits may define an edge of a flap. Edges of adjacent flaps may separate from each other and form the cover element opening when the flaps bend towards the inside of the housing.

The at least one second slit may also be at least partially formed in the double side adhesive tape that may be used to bond the cover element to the housing. The first slit may also be at least partially formed in the double side adhesive tape. The double side adhesive tape may bend together with the flaps.

At least one of the slits may be a cut through the entire thickness of the cover element. The slits have a slit width of below 0.5 millimeters, in particular below 0.1 millimeters. The first slit may have a greater width than the at least one second slit. The first slit may have a width in between 0.5 millimeters and 0.3 millimeters, preferably 0.4 millimeters. The at least one second slit may have a width in between 0.15 millimeters and 0.0.05 millimeters, preferably 0.1 millimeters. The slits may have no width, namely adjacent slit faces may be in contact with each other. This may improve the sealing function of the flap.

The first slit may extend in a first direction. The at least one second slit may extend in at least one second direction. The at least one second direction may be different from the first direction. Slits extending in different directions may facilitate forming the cover element opening. In particular, due to the slits, tensile stress in the cover element may be reduced or the cover element may be free of tensile stress. This may apply even when the device and cover element are subject to potentially different heat deformations, or during the deformation of the cover element by moving the at least one flap to the open position. This may improve durability of the cover element.

The at least one second direction and the first direction may be arranged at an angle of in between 70 degrees and 170 degrees, in particular in between 90 degrees and 150 degrees, in particular in between 110 degrees and 130 degrees.

The first slit may extend along a substantially straight line in the first direction. The at least one second slit may be connected to an end of the first slit. One or multiple second slits may be connected to a first end of the first slit. One or multiple second slits may be connected to a second end of the first slit.

The at least one second slit may extend beyond the connector opening. This may facilitate the bending of the flap and may reduce stress in the cover element.

The first slit may be arranged substantially in the center of the cover element. The at least one second slit may extend from the first slit in a direction towards the boundary of the cover element. The at least one second slit may be connected to a first end of the first slit and may extend in a direction away from a second end of the first slit.

The cover element may comprise a plurality of second slits. The plurality of second slits may form a substantially symmetrical pattern with respect to a first axis, wherein the first axis may be substantially parallel to the first direction. The first end and the second end of the first slit may be arranged on the first axis. The plurality of second slits may form a substantially symmetrical pattern with respect to a second axis, wherein the second axis may be substantially orthogonal to the first direction. The second axis may extend through a center point of the first slit.

The at least one second slit may be shorter than the first slit. The at least one second slit may have a length of 10 percent to 70 percent, in particular 20 percent to 60 percent, in particular 30 percent to 50 percent of the length of the first slit. The first slit may have a length of 5 millimeters to 20 millimeters, preferably 8 millimeters to 12 millimeters. The at least one second slit may have a length of 1 millimeter to 10 millimeters.

The cover element may comprise four second slits. The second slits may be inclined at an angle of 90 degrees to 150 degrees with respect to the first direction. Two of the four second slits may be connected to a first end of the first slit. The two second slits may extend in different directions with respect to a centerline of the first slit. The two second slits may extend in a direction away from a second end of the first split. The other two of the four second slits may be connected to the second end of the first slit. The two second slits connected to the second end of the first slit may extend in different directions with respect to a centerline of the first slit. The two second slits connected to the second end of the first slit may extend in a direction away from the first end of the first split.

The cover element may comprise a short flap and a long flap. Short and long may refer to the extension of the flap in a direction substantially parallel to an edge of the housing wall that surrounds the connector opening. The connection opening may have a short side and a long side. The short flap may be adjacent to the short side of the connection opening. The long flap may be adjacent to the long side of the connection opening. The short flap and the long flap may be separated by the at least one second slit.

The cover element may comprise two short flaps and two long flaps. The two long flaps may be separated by the first slit. Two adjacent long and short flaps may be separated by a second slit. Two flaps may be arranged on opposite sides of the connector opening. These two opposite flaps may have the same length.

The cover element may have a length of 5 millimeters to 25 millimeters, preferably 10 millimeters to 20 millimeters and a width of 5 millimeters to 10 millimeters. They size of the cover element may be at least the size of the connector opening.

The at least one flap may have a thickness of 0.1 millimeters to 2 millimeters, in particular 0.2 millimeters to 1 millimeter, preferably 0.3 millimeters to 0.5 millimeters. This flap thickness may sufficiently seal the connector opening but may still allow bending of the at least one flap. This flap thickness may enable the flap to elastically move from the open position into the closed position. The attachment portion of the cover element may have the same thickness as the flap. The attachment portion of the cover element may have a lower thickness as the flap. This may improve the flexibility of the flap. The attachment portion of the cover element may have a greater thickness as the flap. This may improve the sealing properties of the flap.

The at least one flap may be made of a thermoplastic elastomer or silicone. In particular, the at least one flap may be made of a thermoplastic elastomer, soft or hard rubber, polytetrafluorethylene, polyurethane, ethylene propylene diene monomer rubber, silicone, nitrile, or a combination thereof. The flap material may be substantially waterproof. The flap material may be substantially impermeable to liquids. The flap material may be able to return to the closed position after being deformed by a bending operation. In particular the flap material may be able to return to a closed position without the application of an external force.

The at least one flap may comprise at least one magnet. In this context, a magnet may be understood as a material which has its component atoms ordered in such a way that it exhibits properties of magnetism. A magnet may produce a substantially persistent magnetic field even in the absence of an applied magnetic field.

The at least one magnet may be attached to or embedded in the at least one flap. The at least one flap may have magnetic material properties. The flap may be formed of a magnetic material, in particular a self-adhesive magnetic material.

The at least one magnet or the magnetic material may interact with another magnet or a metal embedded in the attachment portion or in another flap.

The at least one magnet may be attached to an inner surface or outer surface of the at least one flap. The at least one magnet may be located adjacent to a slit. The at least one magnet may be adapted to facilitate moving the at least one flap into the closed position. The at least one magnet may be adapted to facilitate retaining the at least one flap in a closed position. The at least one magnet may improve the sealing of the cover element. The at least one magnet may attract adjacent flap edges, which are separated by a slit, to each other when the flaps are in a closed position.

The magnetic material may facilitate moving the at least one flap into the closed position. The magnetic material may facilitate keeping the at least one flap in the closed position. The magnetic material may improve the sealing of the cover element. The magnetic material may attract adjacent flap edges, which are separated by a slit, to each other when the flaps are in a closed position.

The outer surface of the housing wall may comprise at least one connector opening edge adjacent to the connector opening. The at least one connector opening edge may be adapted to be in surface contact with the respective at least one flap. Surface contact may refer to an area of the at least one connector opening edge being in contact with an area of the at least one flap.

The at least one connector opening edge may be rounded or chamfered. The rounded or chamfered design may allow the at least one connector opening edge to be in surface contact with the at least one flap.

The at least one flap may be adapted to bend along the connector opening edge. The rounded or chamfered design of the connector opening edge may provide a smooth support for the at least one flap, when the at least one flap is in the open position. In the open position, the at least one flap may be in contact with the connector opening edge and may follow the surface of the connector opening edge. The rounded or chamfered edge may improve durability of the flap.

Two adjacent connector opening edges may be separated by a recess. The recess may be formed in the housing wall. The recess may reduce stress, in particular tensile stress, in the cover element when the at least one flap is bend into the open position. The edges of the recess may have the same shape as the connector opening edges, in particular they may be rounded or chamfered. The at least one second slit may extend towards the location of the recess.

The ratio of the fillet radius of the connector opening edge to the thickness of the flap is in between 0.5 to 10, preferably between 1 and 5. The fillet radius of the connector opening edge is 1 millimeter to 50 millimeters, in particular 3 millimeters to 25 millimeters, in particular 5 millimeters to 10 millimeters. Such a radius may result in a smooth bending of the flap and may increase the durability of the flap.

The aerosol-generating system may further comprise an electrical connector. The electrical connector may comprise an electrical connector casing. The electrical connector casing may have a plug reception opening and may have a connection flange. The connection flange may extend at least partially around the plug reception opening. Preferably, the connection flange extends circumferentially around the plug reception opening. The connection flange may have an oval or circular ring shape. The aerosol-generating system may further comprise a sealing member. The sealing member may be arranged between the electrical connector and the housing, in particular the housing wall.

The at least one flap may be in contact with an edge of the electrical connector when the at least one flap is in the open position. The at least one flap may form a bulge when in contact with an edge of the electrical connector. The at least one flap may be moved past the electrical connector, such that the at least one flap does not get in contact with the electrical connector and no bulge may be formed. In the position, the extension of the at least one flap towards the inside of the aerosol-generating system may be less than or equal the distance between the electrical connector and the housing wall. In the closed position, the distance the at least one flap extends beyond the connector opening edge towards the center of the connector opening may be less than or equal the distance between the electrical connector and the housing wall. In the closed position, the distance the at least one flap overlaps with the connector opening may be less than or equal the distance between the electrical connector and the housing wall.

The electrical connector may be a USB connector, in particular a USB Type C Connector. The electrical connector casing may house an electrically conductive part. An electrical plug may be inserted into the plug reception opening to mate with the electrically conductive part.

The connection flange may be attached to the electrical connector casing. The connection flange may be attached to the electrical connector casing my means of laser welding.

The connection flange may form part of the electrical connector casing. In particular, the connection flange and the electrical connector casing may be formed from a unitary piece.

The connection flange may protrude laterally from the electrical connector casing. In this context, laterally means that the electrical connector casing may extend substantially along a longitudinal casing axis and the connection portion may protrude from the electrical connector casing in directions orthogonal to the longitudinal casing axis. The connection flange may be arranged in the front part of the electrical connector. The connection flange may define a front surface of the electrical connector. In particular, the connection flange may enlarge the front surface of the electrical connector. Front is defined as the direction from which a plug may be inserted into the electrical connector.

The connection flange may protrude at least 1 millimeter, preferably at least 2 millimeters, preferably at least 3 millimeters from the electrical connector casing. These values may ensure that the connection flange provides a sufficiently large support for the sealing member. The connection flange may protrude a maximum of 20 millimeters from the electrical connector casing. The connection flange may have a length of 8 millimeters to 12 millimeters, preferably 9 millimeters to 11 millimeters. The length of the connection flange may be defined as the distance from a first end of the connection flange to a second end of the connection flange along a direction in which the connection flange may predominantly extend. The connection flange may have a width of 3 millimeters to 6 millimeters, preferably 3.5 millimeters to 4.5 millimeters. The width of the connection flange may be defined as the distance from a first end of the connection flange to a second end of the connection flange in a direction orthogonal to the direction in which the connection flange may predominantly extend.

The connection flange may be made of metal, preferably stainless steel. The connection flange may be a metal ring. The connection flange may be made of a polymer material.

The sealing member may abut on an inner surface of the housing wall. The housing wall may comprise a groove formed into the inner surface of the housing wall to receive the sealing member. The groove may extend circumferentially around the connector opening and may keep the sealing member in place.

The inner surface of the housing wall may be treated, in particular using computer numerical control, to provide a smooth surface. The smooth surface may improve the tightness of the sealing member and may improve the sealing capacity.

The sealing member may also abut on a front surface of the connection flange. The sealing member may seal the area between the front surface of the connection flange and the inner surface of the housing wall.

The sealing member may reduce the ingress of liquids and contaminations into the aerosol-generating system. The sealing member may extend circumferentially around the connector opening. The sealing member may extend circumferentially around the plug reception opening.

The cover element may be attached to the inner surface of the housing wall, and the sealing member may abut on the cover element. A spacing element may be provided between the sealing member and the housing wall. A spacing element may be provided between the sealing member and the connection flange.

The sealing member may be attached to the inner surface of the housing wall by means of an adhesive, in particular glue, or double side adhesive tape. The sealing member may be attached to the connection flange by means of an adhesive, in particular glue, or double side adhesive tape.

The sealing member may be molded onto the connection flange, in particular by injection molding or compression molding, preferably by liquid injection molding. Molding may improve the sealing between the electrical connector and the sealing member. In addition, molding may reduce the risk of detachment of the sealing member from the connection flange and may result in a robust design. When the sealing member is molded onto the connection flange, the sealing member may also abut on a lateral surface of the electrical connector casing.

The sealing member may be an O-ring. The sealing member may be made of foam. The sealing member may be made of a thermoplastic elastomer, rubber, polytetrafluorethylene, polyurethane, ethylene propylene diene monomer rubber, silicone, nitrile, or a combination thereof.

The sealing member may have a thickness of 0.5 millimeters to 5 millimeters, preferably 1 millimeter to 3 millimeters, preferably 1.5 millimeters to 2.5 millimeters. The thickness of the sealing member may be defined as the extension of the sealing member in the longitudinal direction of the electrical connector.

The sealing member may have a width of 0.5 millimeters to 10 millimeters, preferably 1 millimeter to 5 millimeters, preferably 2 millimeters to 3 millimeters. The width of the sealing member may be defined as the distance from an inner edge of the sealing member to and outer edge of the sealing member in a lateral direction of the electrical connector.

The sealing member may have a length of 8 millimeters to 12 millimeters, preferably 9 millimeters to 11 millimeters. The length of the sealing member may be defined as the distance from a first end of the sealing member to a second end of the sealing member in a direction in which the sealing member may predominantly extend. The extension of the sealing member orthogonal to the direction in which the sealing member may predominantly extend may be 3 millimeters to 5 millimeters, preferably 3.5 millimeters to 4.5 millimeters.

The sealing member may be arranged in a lateral distance from the plug reception opening to form a lateral clearance between the sealing member and the plug reception opening. The lateral clearance may allow a plug to be inserted into the plug reception opening without interfering with the sealing member. Such a configuration may improve durability of the sealing member and usability of the aerosol-generating system. An inner surface of the sealing member may be substantially flush with the connector opening in the housing. An inner edge of the sealing member may be aligned with the connector opening in the housing. The lateral clearance may be the lateral distance between the connector opening and the plug reception opening.

The lateral clearance may extend circumferentially around the plug reception opening. The lateral clearance may have a width of at least 0.1 millimeters, in particular 0.2 millimeters, in particular at least 0.3 millimeters. The maximum width of the lateral clearance may be 30 millimeters. The lateral clearance may be uniform along its extension around the plug reception opening. The lateral clearance may have substantially the same width along its extension around the plug reception opening. The width of the lateral clearance may vary along its extension around the plug reception opening, in particular it may vary depending on the shape of a plug that may be inserted into the plug reception opening. The lateral clearances may also include an additional assembly tolerance.

An inner edge of the sealing member may be aligned with the connector opening of the housing. The inner edge of the sealing member may be retracted with respect to the connector opening. This may protect the sealing member, in particular from sun light or external objects. Such a configuration may improve durability of the sealing member.

According to a third aspect of the invention, there is provided an assembly method for an aerosol-generating system, in particular according to the first or second aspect of the invention. The assembly method comprises the following steps: A housing part with a connector opening is provided. A cover element is attached to the housing part of the aerosol-generating system. An electrical connector is placed inside the housing part. The cover element covers the connector opening and comprises a flap.

The assembly method may further comprise the step of attaching a sealing member to the electrical connector.

The assembly method may further comprise the step of attaching the sealing member to an inner surface of the housing part, in particular adjacent to the connector opening.

The assembly method steps may be performed in any possible order.

According to a fourth aspect of the invention, there is provided an assembly method for an aerosol-generating system, in particular according to the first or second aspect of the invention. The assembly method comprises the following steps: A sealing member is attached to an electrical connector. The electrical connector is placed inside a housing of the aerosol-generating system. The sealing member is attached to an inner surface of the housing, in particular adjacent to a connector opening in the housing.

The assembly method may also comprise the step of forming a connection flange on the electrical connector, preferably on a front section of the electrical connector, to enlarge a front surface of the electrical connector. The front surface may face the housing wall.

The assembly method may also comprise the step of attaching a connection flange to the electrical connector to enlarge a front surface of the electrical connector.

The sealing member may be attached to a surface of the connection flange facing the housing wall.

Attaching the sealing member to the electrical connector may comprise the step of molding the sealing member onto the connection flange, preferably by liquid injection molding.

According to a fifth aspect of the invention, there is provided a use of a flap in an aerosol-generating system, in particular according to the first or second aspect of the invention, to reduce the ingress of dust and liquid through a connector opening. Using a flap may provide an efficient and fast way to uncover the connector opening, thus it may improve usability of the aerosol-generating system.

According to a sixth aspect of the invention, there is provided a use of a sealing member in an aerosol-generating system, in particular according to the first or second aspect of the invention, to seal the space between an electrical connector inside the aerosol-generating system and a housing wall of the aerosol-generating system against the ingress of dust and liquid. This may prevent the ingress of liquid and dust. This may improve durability and usability of the aerosol-generating system.

The system according to the first or second aspect of the invention may be assembled according to the method of the third or fourth aspect of the invention. The assembly method according to the third or fourth aspect of the invention may be used to assembly the system according to the first or second aspect of the invention. The use of a flap according the fifth aspect of the invention may be performed with the system according to the first or second aspect of the invention and by using method steps from the method according to the third or fourth aspect of the invention. The use of a sealing member according the sixth aspect of the invention may be performed with the system according to the first or second aspect of the invention and by using method steps from the method according to the third or fourth aspect of the invention.

The invention is defined in the claims. However, below there is provided a non-exhaustive list of non-limiting examples. Any one or more of the features of these examples may be combined with any one or more features of another example, embodiment, or aspect described herein.

Example Ex1: A system, for example, an aerosol-generating system, comprising a housing, wherein the housing comprises a connector opening, in particular an opening for an electrical connector, wherein the connector opening is at least partially covered by a cover element, wherein the cover element comprises at least one flap, wherein the at least one flap is movable from a closed position to an open position.

Example Ex2: A system, for example, an aerosol-generating system, according to example Ex1, wherein the at least one flap is adapted to open towards the inside of the housing.

Example Ex3: A system, for example, an aerosol-generating system, comprising a housing, an electrical connector, and a sealing member, wherein the housing comprises a housing wall, wherein the electrical connector comprises a plug reception opening and a connection flange, wherein the connection flange extends at least partially around the plug reception opening, wherein the sealing member is arranged between the connection flange and an inner surface of the housing wall.

Example Ex4: A system, for example, an aerosol-generating system, according to example Ex3, wherein the housing comprises a connector opening, wherein the connector opening is covered by a cover element, wherein the cover element comprises at least one flap, wherein the at least one flap is adapted to open towards the inside of the housing.

Example Ex5: A system, for example, an aerosol-generating system, according to example Ex3 or Ex4, wherein the sealing member is arranged in a lateral distance from the plug reception opening to form a lateral clearance between the sealing member and the plug reception opening.

Example Ex6: A system, for example, an aerosol-generating system, according to any one of examples Ex3 to Ex5, wherein the sealing member is arranged in a lateral distance from the inner opening of the connection flange to form a lateral clearance between the sealing member and the inner opening of the connection flange.

Example Ex7: A system, for example, an aerosol-generating system, according to any one of examples Ex5 to Ex6, wherein the lateral clearance extends circumferentially around the plug reception opening.

Example Ex8: A system, for example, an aerosol-generating system, according to any one of examples Ex5 to Ex7, wherein the lateral clearance has a width of at least 0.1 millimeters, in particular at least 0.2 millimeters, preferably at least 0.3 millimeters.

Example Ex9: A system, for example, an aerosol-generating system, according to any one of examples Ex1 to Ex8, wherein the connector opening has a substantially oval shape.

Example Ex10: A system, for example, an aerosol-generating system, according to any one of examples Ex1 to Ex9, wherein the aerosol-generating system comprises a battery charger and an aerosol-generating device, wherein the housing forms part of the battery charger.

Example Ex11: A system, for example, an aerosol-generating system, according to any one of examples Ex1 to Ex9, wherein the aerosol-generating system comprises an aerosol-generating device, wherein the housing forms part of the aerosol-generating device.

Example Ex12: A system, for example, an aerosol-generating system, according to any one of examples Ex1 to Ex11, wherein the aerosol-generating system comprises an aerosol-generating article with an aerosol-generating substrate.

Example Ex13: A system, for example, an aerosol-generating system, according to any one of examples Ex1 to Ex12, wherein the aerosol-generating device comprises a cavity, wherein the cavity is adapted to receive an aerosol-generating article with an aerosol-generating substrate.

Example Ex14: A system, for example, an aerosol-generating system, according to any one of examples Ex1 to Ex13, wherein the housing comprises a housing wall and the cover element is attached to an inner surface of the housing wall.

Example Ex15: A system, for example, an aerosol-generating system, according to any one of examples Ex1 to Ex13, wherein the housing comprises a housing wall, and the cover element is attached to an outer surface of the housing wall.

Example Ex16: A system, for example, an aerosol-generating system, according to example Ex14 or Ex15, wherein the cover element overlaps with the housing wall, in particular by 0.5 millimeters to 10 millimeters, preferably by 1 millimeter to 5 millimeters.

Example Ex17: A system, for example, an aerosol-generating system, according to any one of examples Ex1 to Ex16, wherein the cover element substantially seals the connector opening when the at least one flap is in the closed position.

Example Ex18: A system, for example, an aerosol-generating system, according to any one of examples Ex1 to Ex17, wherein the cover element comprises an attachment portion, wherein the at least one flap is connected to the attachment portion and the at least one flap is adapted to bend towards the inside of the housing, while the attachment portion remains stationary.

Example Ex19: A system, for example, an aerosol-generating system, according to example Ex18, wherein the attachment portion is at least partially attached to the housing wall.

Example Ex20: A system, for example, an aerosol-generating system, according to examples Ex18 or Ex19, wherein the attachment portion extends at least partially around the at least one flap.

Example Ex21: A system, for example, an aerosol-generating system, according to any one of examples Ex1 to Ex20, wherein the at least one flap is adapted to elastically move from an open position to a closed position.

Example Ex22: A system, for example, an aerosol-generating system, according to any one of examples Ex1 to Ex21, wherein a cover element opening is formed in the cover element when the at least one flap is in an open position.

Example Ex23: A system, for example, an aerosol-generating system, according to any one of examples Ex18 to Ex20, wherein the cover element comprises at least one bending line between the at least one flap and the attachment portion.

Example Ex24: A system, for example, an aerosol-generating system, according to any one of examples Ex1 to Ex23, wherein the cover element comprises a first slit and at least one second slit, wherein the at least one second slit is connected to the first slit.

Example Ex25: A system, for example, an aerosol-generating system, according to example Ex24, wherein the first slit extends in a first direction and the at least one second slit extends in at least one second direction, wherein the at least one second direction is different from the first direction.

Example Ex26: A system, for example, an aerosol-generating system, according to example Ex25, wherein the at least one second direction and the first direction are arranged at an angle of in between 70 degrees and 170 degrees, preferably in between 90 degrees and 150 degrees.

Example Ex27: A system, for example, an aerosol-generating system, according to any one of examples Ex24 to Ex26, wherein the first slit extends along a substantially straight line in a first direction.

Example Ex28: A system, for example, an aerosol-generating system, according to any one of examples Ex24 to E27, wherein the at least one second slit is connected to an end of the first slit.

Example Ex29: A system, for example, an aerosol-generating system, according to any one of examples Ex24 to Ex28, wherein the at least one second slit extends beyond the connector opening.

Example Ex30: A system, for example, an aerosol-generating system, according to any one of examples Ex1 to Ex29, wherein the cover element comprises a short flap and a long flap.

Example Ex31: A system, for example, an aerosol-generating system, according to example Ex30, wherein two flaps are arranged on opposite sides of the connector opening, wherein these two opposite flaps have the same length.

Example Ex32: A system, for example, an aerosol-generating system, according to any one of examples Ex1 to Ex31, wherein the at least one flap has a thickness of 0.1 millimeters to 2 millimeters, in particular 0.2 millimeters to 1 millimeter, preferably 0.3 millimeters to 0.5 millimeters.

Example Ex33: A system, for example, an aerosol-generating system, according to any one of examples Ex1 to Ex32, wherein the at least one flap is made of a thermoplastic elastomer or silicone.

Example Ex34: A system, for example, an aerosol-generating system, according to any one of examples Ex1 to Ex33, wherein the at least one flap comprises at least one magnet.

Example Ex35: A system, for example, an aerosol-generating system, according to any one of examples Ex1 to Ex34, wherein the at least one flap has magnetic material properties.

Example Ex36: A system, for example, an aerosol-generating system, according to any one of examples Ex1 to Ex35, wherein at least one magnet is attached to or embedded in the at least one flap.

Example Ex37: A system, for example, an aerosol-generating system, according to any one of examples Ex1 to Ex36, wherein the outer surface of the housing wall comprises at least one connector opening edge adjacent to the connector opening, wherein the at least one connector opening edge is adapted to be in surface contact with the respective at least one flap.

Example Ex38: A system, for example, an aerosol-generating system, according to any one of examples Ex1 to Ex37, wherein the outer surface of the housing wall comprises at least one connector opening edge adjacent to the connector opening, wherein the at least one flap is adapted to bend along the at least one connector opening edge.

Example Ex39: A system, for example, an aerosol-generating system, according to example Ex37 or Ex38, wherein the at least one connector opening edge is rounded or chamfered.

Example Ex40: A system, for example, an aerosol-generating system, according to any one of examples Ex37 to Ex39, wherein two adjacent connector opening edges are separated by a recess.

Example Ex41: A system, for example, an aerosol-generating system, according to example Ex40, wherein the at least one second slit extends in the region of the recess.

Example Ex42: A system, for example, an aerosol-generating system, according to example Ex39, wherein the ratio of the fillet radius of the at least one connector opening edge to the thickness of the at least one flap is in between 0.5 and 10, preferably between 1 and 5.

Example Ex43: A system, for example, an aerosol-generating system, according to example Ex39 or Ex42, wherein the fillet radius of the at least one connector opening edge is 1 millimeter to 50 millimeters, in particular 3 millimeters to 25 millimeters, in particular 5 millimeters to 10 millimeters.

Example Ex44: A system, for example, an aerosol-generating system, according to any one of examples Ex1 to Ex43, further comprising an electrical connector, wherein the electrical connector comprises an electrical connector casing with a plug reception opening, and a connection flange extending at least partially around the plug reception opening, and a sealing member, wherein the sealing member is arranged between the electrical connector and the housing.

Example Ex45: A system, for example, an aerosol-generating system, according to example Ex44, wherein the connection flange extends circumferentially around the plug reception opening.

Example Ex46: A system, for example, an aerosol-generating system, according to example Ex44 or Ex45, wherein the connection flange is attached to the electrical connector casing or forms part of the electrical connector casing.

Example Ex47: A system, for example, an aerosol-generating system, according to any one of examples Ex44 to Ex46, wherein the connection flange protrudes laterally from the electrical connector casing, in particular at least 1 millimeter, preferably at least 2 millimeters, preferably at least 3 millimeters.

Example Ex48: A system, for example, an aerosol-generating system, according to any one of examples Ex3 to Ex47, wherein the sealing member abuts on an inner surface of the housing wall, and the sealing member abuts on a front surface of the connection flange.

Example Ex49: A system, for example, an aerosol-generating system, according to any one of examples Ex3 to Ex48, wherein a groove is formed on the inner surface of the housing wall to receive the sealing member.

Example Ex50: A system, for example, an aerosol-generating system, according to any one of examples Ex3 to Ex49, wherein the sealing member extends circumferentially around the plug reception opening and the connector opening in the housing wall.

Example Ex51: A system, for example, an aerosol-generating system, according to any one of examples Ex3 to Ex50, wherein the sealing member is attached to the connection flange by means of an adhesive, in particular glue, or double side adhesive tape.

Example Ex52: A system, for example, an aerosol-generating system, according to any one of examples Ex3 to Ex51, wherein the sealing member is molded onto the connection flange, in particular by liquid injection molding.

Example Ex53: A system, for example, an aerosol-generating system, according to any one of examples Ex44 to Ex52, wherein the sealing member is arranged in a lateral distance from the plug reception opening to form a lateral clearance between the sealing member and the plug reception opening.

Example Ex54: A system, for example, an aerosol-generating system, according to example Ex53, wherein the lateral clearance extends circumferentially around the plug reception opening.

Example Ex55: A system, for example, an aerosol-generating system, according to example Ex53 or Ex54, wherein the lateral clearance has a width of at least 0.1 millimeters, in particular at least 0.2 millimeters, preferably at least 0.3 millimeters.

Example Ex56: Assembly method, for example, an assembly method for an aerosol-generating system, in particular according to any one of examples Ex1 to Ex55, comprising the steps of:
providing a housing part with a connector opening,
attaching a cover element to the housing part of the aerosol-generating system, and
placing an electrical connector inside the housing part, wherein the cover element covers the connector opening and comprises a flap.

Example Ex57: Assembly method, for example, an assembly method for an aerosol-generating system, according to example Ex56, wherein the assembly method further comprises the steps of
attaching a sealing member to the electrical connector, and
attaching the sealing member to an inner surface of the housing part, in particular adjacent to the connector opening.

Example Ex58: Assembly method, for example, an assembly method for an aerosol-generating system, in particular according to any one of examples Ex1 to Ex55, comprising the steps of:
attaching a sealing member to an electrical connector,
placing the electrical connector inside a housing of the aerosol-generating system, and
attaching the sealing member to an inner surface of the housing, in particular adjacent to a connector opening in the housing.

Example Ex59: Use of a flap, for example, use of a flap in an aerosol-generating system, in particular to any one of examples Ex1 to Ex55, to reduce the ingress of dust and liquid through a connector opening.

Example Ex60: Use of a flap, for example, use of a flap in an aerosol-generating system, in particular to any one of examples Ex1 to Ex55, to seal the space between an electrical connector inside the aerosol-generating system and a housing wall of the aerosol-generating system against the ingress of dust and liquid.

Example Ex61: A system, for example, an aerosol-generating system, according to any one of examples Ex1 to Ex55, further comprising an aerosol-generating article comprising an aerosol-generating substrate.

The examples will now be further described with reference to the figures.

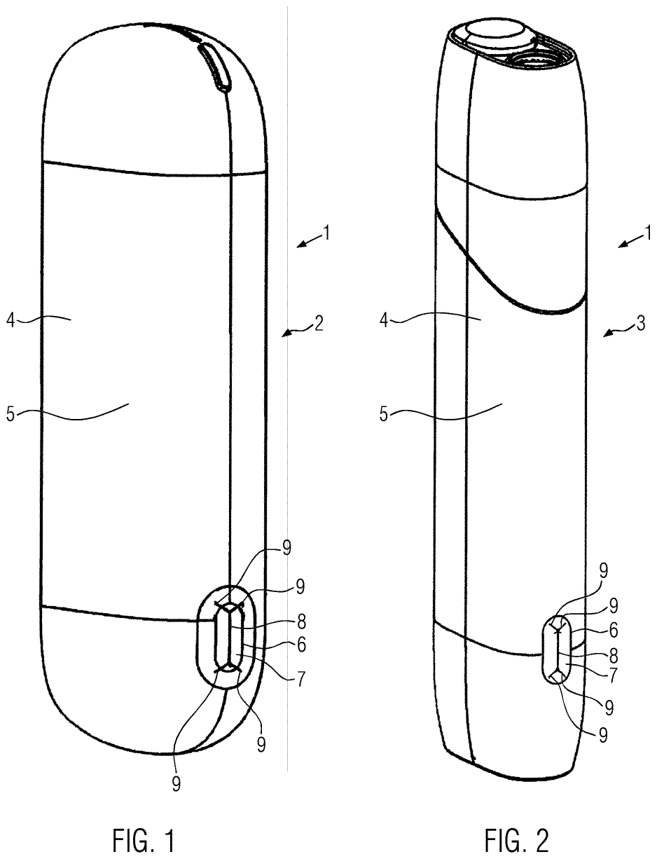

FIG. 1 shows a perspective view of an aerosol-generating system according to an embodiment of the invention.

FIG. 2 shows a perspective view of an aerosol-generating system according to another embodiment of the invention.

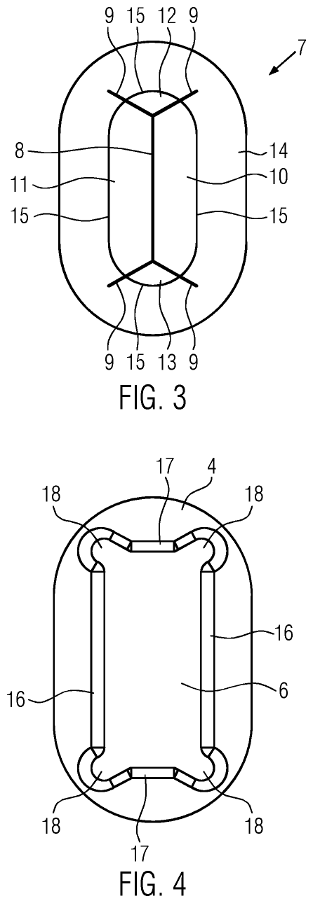

FIG. 3 shows a front view of the cover element of the aerosol-generating system of FIG. 1.

FIG. 4 shows a front view of the connector opening of the aerosol-generating system of FIG. 1.

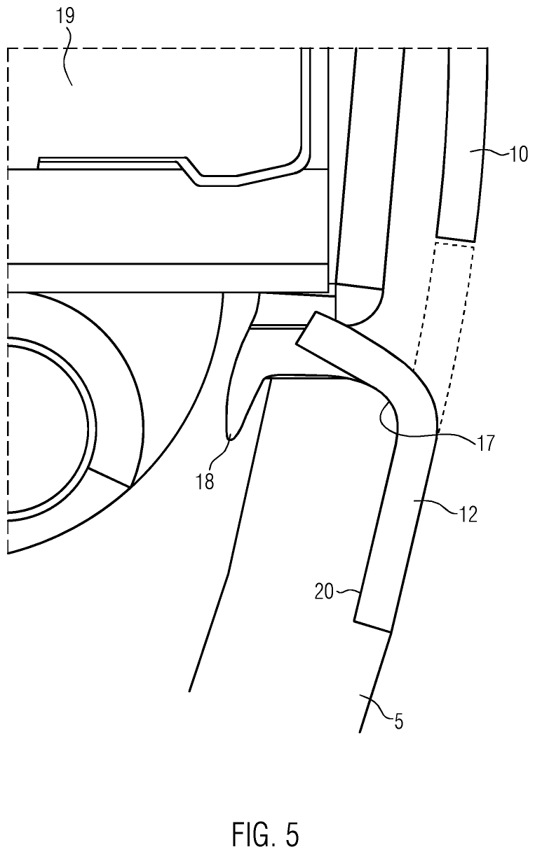

FIG. 5 shows a partial cross-sectional view of the aerosol-generating system of FIG. 1 in the area of the connector opening and the cover element.

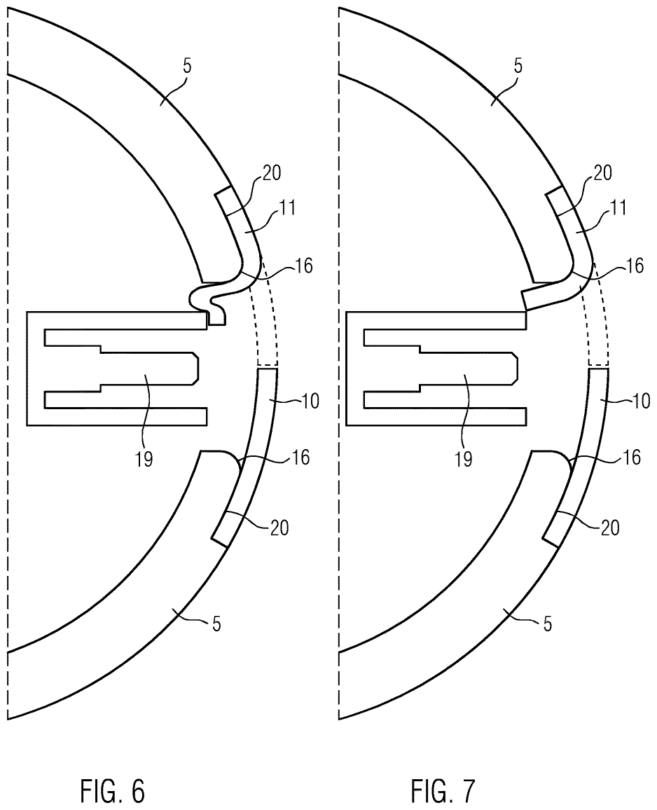

FIG. 6 shows a partial cross-sectional view of the aerosol-generating system of FIG. 1 in the area of the connector opening and the cover element, which is rotated by 90 degrees with respect to the view of FIG. 5.

FIG. 7 shows a partial cross-sectional view of the same area as in FIG. 6 but for a different embodiment.

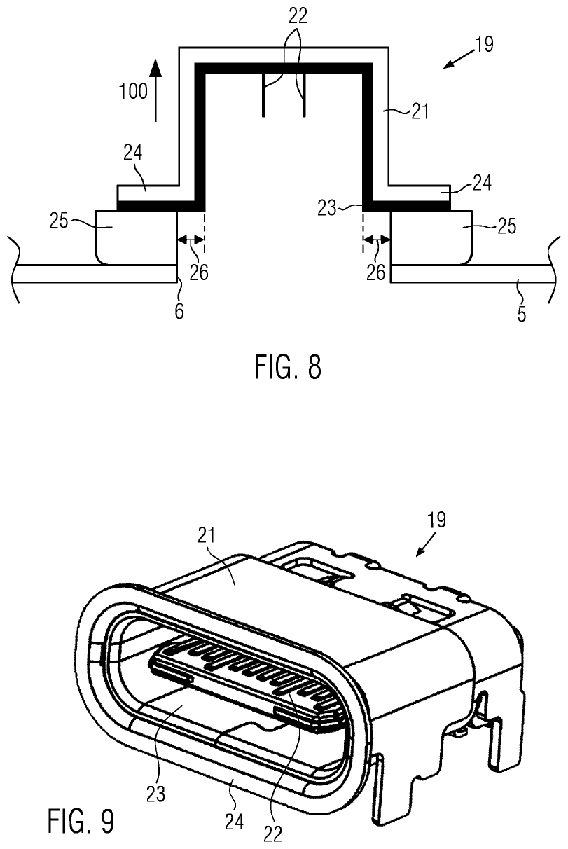

FIG. 8 is an illustration of an electrical connector attached to a housing wall according to an embodiment of the invention.

FIG. 9 shows a perspective view of an electrical connector according to an embodiment of the invention.

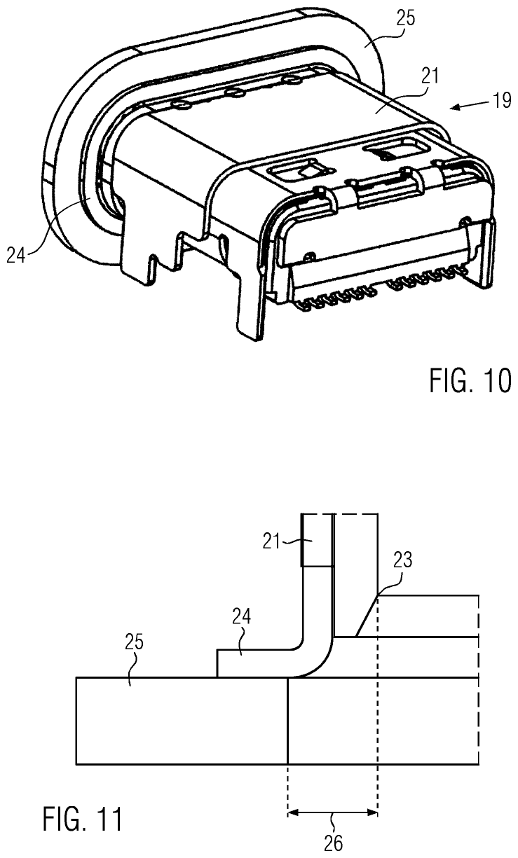

FIG. 10 shows a perspective rear view of the electrical connector of FIG. 9 and a sealing member.

FIG. 11 shows a partial cross-sectional view of the electrical connector and sealing member of FIG. 10.

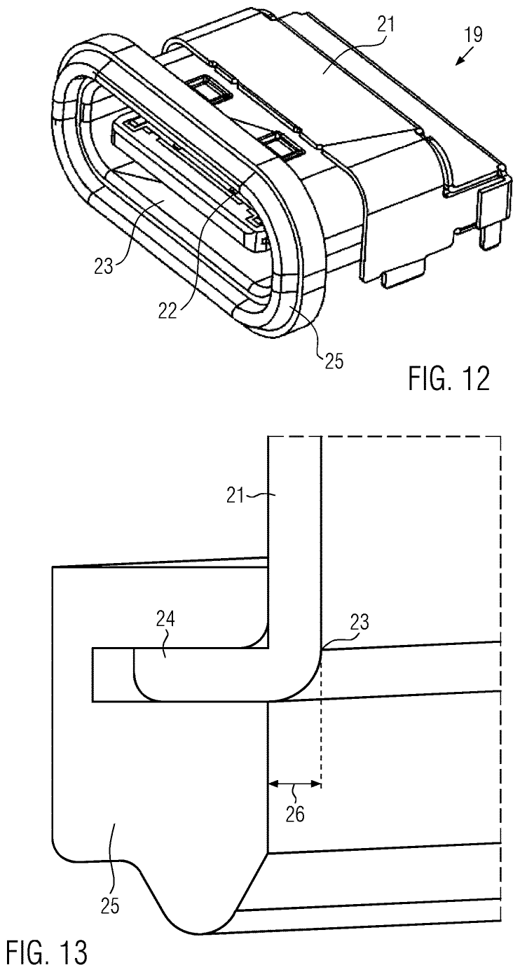

FIG. 12 shows a perspective view of an electrical connector and a sealing member according to another embodiment of the invention.

FIG. 13 shows a partial cross-sectional view of the electrical connector and sealing member of FIG. 12.

An aerosol-generating system 1 according to an embodiment of the invention is shown in FIG. 1. In this embodiment, the aerosol-generating system comprises a battery charger 2 and an aerosol-generating device. The aerosol-generating device is not shown in FIG. 1 but may be arranged inside the battery charger 2. The battery charger 2 comprises a housing 4 with a housing wall 5. A connector opening 6 is formed inside the housing wall 5. The connector opening 6 is covered by a cover element 7. The cover element 7 is attached to an outer surface of the housing wall 5. The cover element 7 comprises a first slit 8 and four second slits 9.

An aerosol-generating system 1 according to another embodiment of the invention is shown in FIG. 2. In this embodiment, the aerosol-generating system 1 comprises an aerosol-generating device 3. The aerosol-generating device 2 comprises a housing 4 with a housing wall 5. A connector opening 6 is formed inside the housing wall 5. The connector opening 6 is covered by a cover element 7. The cover element 7 is attached to an inner surface of the housing wall 5. The cover element 7 comprises a first slit 8 and four second slits 9.

It is also possible that the cover element 7 of the aerosol-generating device 3 of FIG. 2 is attached to an outer surface of the housing wall 5, as shown in FIG. 1. The cover element 7 of the battery charger 2 of FIG. 1 can also be attached to an inner surface of the housing wall 5, as shown in FIG. 2.

FIG. 3 shows the cover element 7 of FIG. 1. The cover element 7 comprises a first long flap 10, a second long flap 11, a first short flap 12 and a second short flap 13. An attachment portion 14 extends circumferentially around the flaps 10, 11, 12, 13. The cover element 7 comprises bending lines 15. In FIG. 3, the flaps 10, 11, 12, 13 are in the closed position. The cover element 7 seals the connector opening 6 in the closed position. When a plug is pushed against the flaps 10, 11, 12, 13, they bend inwards and form an opening in the cover element 7.

FIG. 4 shows the connector opening 6 in the housing wall 5 of the battery charger 2 of FIG. 1. The connector opening 6 is surrounded by two long connector opening edges 16 and two short connector opening edges 17 on the outer surface of the housing wall 5. The connector opening edges 16, 17 are rounded to provide a smooth support for the cover element 7 to bend over. Recesses 18 are formed in the housing wall 5 between two adjacent connector opening edges 16, 17. The edges of the recesses 18 are also rounded.

FIG. 5 shows a cross-sectional view of the connector opening 6. Short flap 12 is in the open position and long flap 10 is in the closed position. This is only for illustrational purpose. Usually all flaps 10, 11, 12, 13 are moved together in the open position when a plug is pushed against them. Short flap 12 bends along short connector opening edge 17 towards the inside of the housing 4 and uncovers the electrical connector 19. FIG. 5 also shows that a recessed section 20 is formed in the outer surface of the housing wall 5 to receive short flap 12, such that the aerosol-generating system 1 has a smooth outer surface.

In FIG. 6, first long flap 10 and second long flap 11 are attached to the recessed section 20 in the outer surface of the housing wall 5. Second long flap 11 bends along long connector opening edge 16 to open towards the inside of the housing 4 and uncovers the electrical connector 19. Second long flap 11 gets in contact with an edge of the connector 19 and forms a bulge. First long flap 10 is in the closed position.

FIG. 7 shows the same area of the aerosol-generating system 1 as FIG. 6 but for a different embodiment. In this embodiment, the electrical connector 19 is retracted more towards the inside of the aerosol-generating system 1, compared to FIG. 6. Second long flap 11 is able to move past the electrical connector 19.

FIG. 8 shows an illustration of how the electrical connector 19 is attached to the housing wall 5. The electrical connector 19 extends predominantly in a longitudinal direction 100. The electrical connector 19 comprises an electrical connector casing 21 that houses electrical conductive parts 22. The electrical connector casing 21 has a plug reception opening 23 arranged adjacent to the connector opening 6 of the housing wall 5. The electrical connector 19 further comprises a connection flange 24. In this embodiment, the connection flange 24 and the electrical connector casing 21 are formed from a unitary piece. A sealing member 25 is arranged between the housing wall 5 and the connection flange 24. The sealing member 25 abuts on the inner surface of the housing wall 5 and on a front surface of the connection flange 24. FIG. 8 shows a lateral clearance 26 between the plug reception opening 23 and the sealing member 25.

FIGS. 9 and 10 show the electrical connector 19 of an embodiment of the invention. The electrical connector casing 21 houses electrically conductive parts 22. The sealing member 25 abuts on the front surface of the connection flange 24 and extend circumferentially around the plug reception opening 23. The connection flange 24 also extends circumferentially around the plug reception opening 23. The inner edge of the connection flange 24 is rounded or chamfered.

FIG. 11 shows a partial horizontal cut through FIG. 10. In this embodiment, the connection flange 24 is a separate part that is attached to the electrical connector casing 21. The sealing member 25 is arranged in a lateral distance from the plug reception opening 23 to form a lateral clearance 26.

FIG. 12 shows the electrical connector 19 and the sealing member 25 according to the embodiment of FIG. 8. FIG. 13 shows a horizontal cut through the electrical connector 19 of FIG. 12. In this embodiment, the electrical connector casing 21 and the connection flange 24 are formed from a unitary piece. The sealing member 25 is molded onto the connection flange 24. Both the connection flange 24 and the sealing member 25 extend circumferentially around the plug reception opening 23. The sealing member 25 is arranged in a lateral distance from the plug reception opening 23 to form a lateral clearance 26.

FIGS. 5 to 12 show an electrical connector 19. Alternatively, the connector may be any type of connector, for example a gas charging port or a liquid charging port.

1.-15. (canceled)

16. An aerosol-generating system, comprising:
a housing comprising a connector opening,
wherein the connector opening is at least partially covered by a cover element,
wherein the cover element comprises at least one flap,
wherein the at least one flap is movable from a closed position to an open position,
wherein the at least one flap is configured to open towards an inside of the housing,
wherein an outer surface of a housing wall comprises at least one connector opening edge adjacent to the connector opening, and
wherein the at least one connector opening edge is configured to be in surface contact with the respective at least one flap.

17. The aerosol-generating system according to claim 16,
further comprising a battery charger and an aerosol-generating device,
wherein the housing forms part of the battery charger.

18. The aerosol-generating system according to claim 16,
wherein the cover element further comprises an attachment portion, and
wherein the at least one flap is connected to the attachment portion and the at least one flap is further configured to bend towards the inside of the housing, while the attachment portion remains stationary.

19. The aerosol-generating system according to claim 16, wherein the at least one flap is made of a thermoplastic elastomer, soft or hard rubber, polytetrafluorethylene, polyurethane, ethylene propylene diene monomer rubber, silicone, nitrile, or a combination thereof.

20. The aerosol-generating system according to claim 16, wherein a cover element opening is formed in the cover element when the at least one flap is in an open position.

21. The aerosol-generating system according to claim 16,
wherein the cover element further comprises a first slit and at least one second slit, and
wherein the at least one second slit is connected to the first slit.

22. The aerosol-generating system according to claim 16, wherein the cover element further comprises a short flap and a long flap.

23. The aerosol-generating system according to claim 16, wherein the at least one flap comprises at least one magnet.

24. The aerosol-generating system according to claim 16, further comprising an electrical connector, the electrical connector comprising:
an electrical connector casing with a plug reception opening,
a connection flange extending at least partially around the plug reception opening, and
a sealing member arranged between the electrical connector and the housing.

25. The aerosol-generating system according to claim 24,
wherein the sealing member abuts on an inner surface of the housing wall and the sealing member abuts on a front surface of the connection flange, and
wherein the sealing member is arranged in a lateral distance from the plug reception opening to form a lateral clearance between the sealing member and the plug reception opening.

26. The aerosol-generating system according to claim 16, further comprising an aerosol-generating article comprising an aerosol-generating substrate.

27. The aerosol-generating system according to claim 16, wherein the at least one flap is further configured to reduce the ingress of dust and liquid through the connector opening.

28. The aerosol-generating system according to claim 16, wherein the at least one connector opening edge is rounded or chamfered.

29. The aerosol-generating system according to claim 16, wherein two adjacent connector opening edges are separated by a recess.

30. An assembly method for the aerosol-generating system according to claim 16, the assembly method comprising the steps of:
providing a housing part with a connector opening;
attaching a cover element to the housing part of the aerosol-generating system; and
placing an electrical connector inside the housing part,
wherein the cover element covers the connector opening and comprises a flap,
wherein the flap is configured to open towards the inside of the housing part,
wherein an outer surface of a housing wall comprises at least one connector opening edge adjacent to the connector opening, and
wherein the at least one connector opening edge is configured to be in surface contact with the flap.

31. The assembly method according to claim 30, wherein the at least one connector opening edge is rounded or chamfered.

32. The assembly method according to claim 30, wherein two adjacent connector opening edges are separated by a recess.
